(19) United States
(12) Patent Application Publication
(10) Pub. No.: US 2005/0275506 A1
(43) Pub. Date: Dec. 15, 2005

(54) Optimization of routing operation in contact center server

(75) Inventor: Kiyokazu Otsuka, Minato-ku (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION

(21) Appl. No.: 11/124,242

(22) Filed: May 9, 2005

(30) Foreign Application Priority Data
May 11, 2004 (JP) 2004-141021

(51) Int. Cl. H04B 1/00

(52) U.S. Cl. 340/5.83

(57) ABSTRACT

A contact center server of the present invention comprises an image recognition unit, an image data search unit, a personal data search unit, a receptionist terminal selector unit, and a call connection unit. The image recognition unit recognizes an image of the face of a caller transmitted from a caller terminal when the caller terminal transmits a call to the contact center server. The image data search unit searches an image data storage unit for face image data which matches the image of the face of the caller from among customer face image data stored in the image data storage unit. The personal data search unit searches a personal data storage unit for personal data corresponding to the customer face image data from among personal data stored in the personal data storage unit. The receptionist terminal selector unit selects one or more receptionist terminals from among a plurality of receptionist terminals based on the customer personal data. The call connection unit connects the call from the caller terminal to a receptionist terminal available for answering the call from among the selected receptionist terminals.

### BACKGROUND OF THE INVENTION

1. Field of the Invention

The present invention relates to a contact center system, a contact center server, and a routing method in the contact center server.

2. Description of the Related Art

Conventionally, in a contact center which accepts claims related to articles and services through telephone calls from customers, a plurality of receptionists such as operators are assigned to answer these telephone calls. In such a contact center, upon receipt of a telephone call from a customer, a routing operation is performed for connecting the call to a terminal of a receptionist who can most effectively handle the telephone (see, for example, Published Japanese Translation of PCT International Publication for Patent Application No. 2002-507356).

FIG. 1 illustrates an exemplary configuration of a conventional contact center which includes a contact center server dedicated to a routing operation. Assume in FIG. 1 that a customer places a telephone call to the contact center server using a portable telephone as a caller terminal.

As shown in FIG. 1, this example of conventional contact center system comprises portable telephone 51; base station 52; communication network 53, contact center server 54, caller number data storage unit 55; personal data storage unit 56; and receptionist terminals 57₁-57ₙ, n being a natural number.

Portable telephone 51 is intended for use by a customer for placing a telephone call to contact center server 54 for claims related to articles and/or services and the like.

Receptionist terminals 57₁-57ₙ are each intended for use by a receptionist who answers a call which has arrived from a customer to contact center server 54.

Contact center server 54 performs a routing operation upon receipt of a telephone call from portable telephone 51 to route the call to one of receptionist terminals 57₁-57ₙ of the receptionist who can most effectively handle the call.

In the following, description will be given of a general operation of this prior art example of contact center system.

First, a caller operates portable telephone 51 to place a call to contact center server 54.

In response, portable telephone 51 transmits a call to contact center server 54 through base station 52 and communication network 53. In this event, a caller number, which is the telephone number of portable telephone 51, is transmitted from portable telephone 51 to contact center server 54.

Contact center server 54 searches caller number data storage unit 55 for a caller number of a customer which matches the caller number transmitted from portable telephone 51, and further searches personal data storage unit 56 for personal data of the customer who corresponds to the caller number. Subsequently, contact center server 54 connects the call from portable telephone 51 to a receptionist terminal available for answering the call from among receptionist terminals 57₁-57ₙ which have been selected based on the personal data of the customer.

However, in the contact center system described above, since a customer is identified by the caller number of a caller terminal, the system implies a problem of inability to identify a plurality of customers who use the same caller terminal. In other words, the contact center system fails to perform an optimal routing operation for each of a plurality of customers who use the same caller terminal.

### SUMMARY OF THE INVENTION

It is therefore an object of the present invention to provide a contact center system, a contact center server, and a routing method in the contact center server, which are capable of identifying each of a plurality of customers, even if they use the same caller terminal, to accomplish an optimal routing operation for each identified customer.

The contact center system of the present invention includes a caller terminal, receptionist terminals, and a contact center server for performing a routing operation to connect a call from the caller terminal to one of the receptionist terminals.

The caller terminal includes image input means and call transmission processing means, and the contact center server includes image recognizing means, image data searching means, personal data searching means, receptionist terminal selecting means, and call connecting means.

Image input means is applied with an image of the face of a caller. The call transmission processing means transmits a call to the contact server, and simultaneously transmits the image of the face of the caller applied to the image input means.

Image recognizing means recognizes the image of the face of the caller transmitted from the caller terminal upon transmission of a call from the caller terminal to the contact center server. The image data searching means searches image data storing means for face image data which matches the image of the face of the caller from among customer face image data stored in the image data storing means. The personal data searching means searches personal data storing means for personal data corresponding to the customer face image data from among personal data stored in the personal data storing means. The receptionist terminal selecting means selects one or more appropriate receptionist terminals from the receptionist terminals based on the customer personal data. The call connecting means connects the call from the caller terminal to a receptionist terminal available for answering the call from among the receptionist terminals selected by the receptionist terminal selecting means.

According to the present invention, when a call from a caller terminal is accepted in the contact center server, the customer is identified from the face image of the caller transmitted simultaneously with the call, and the call is connected to a receptionist terminal based on the personal data of the customer.

Thus, even when a caller terminal is shared by a plurality of customers, the contact center server can perform a routing operation for connecting a call to a receptionist terminal of the receptionist who can most effectively handle the telephone call from the customer on a customer-by-customer basis.

Also, in the contact center server, the image data storing means is searched for face image data which matches an image of the face of a caller transmitted from the caller terminal, and a call is connected to one of the receptionist terminals only when the face image data can be found.

Thus, the service can be provided only for particular customers whose face image data is stored in the image data storing means.

The above and other objects, features and advantages of the present invention will become apparent from the following description with reference to the accompanying drawings which illustrate examples of the present invention.

### BRIEF DESCRIPTION OF THE DRAWINGS

FIG. 1 is a block diagram illustrating an example of a conventional contact center system;

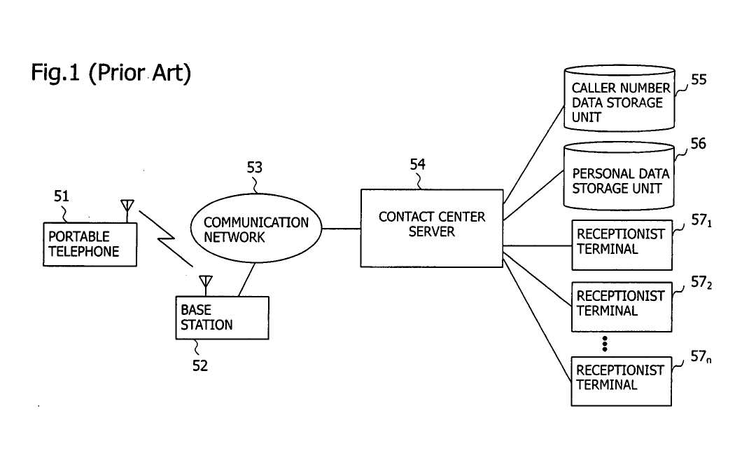

FIG. 2 is a block diagram illustrating the configuration of a contact center system according to a first embodiment of the present invention;

FIG. 3 is a flow chart for describing the operation of the contact center system illustrated in FIG. 2;

FIG. 4 is a block diagram illustrating the configuration of a contact center system according to a second embodiment of the present invention; and

FIG. 5 is a flow chart for describing the operation of the contact center system illustrated in FIG. 4.

### DETAILED DESCRIPTION OF THE EMBODIMENTS

### First Embodiment

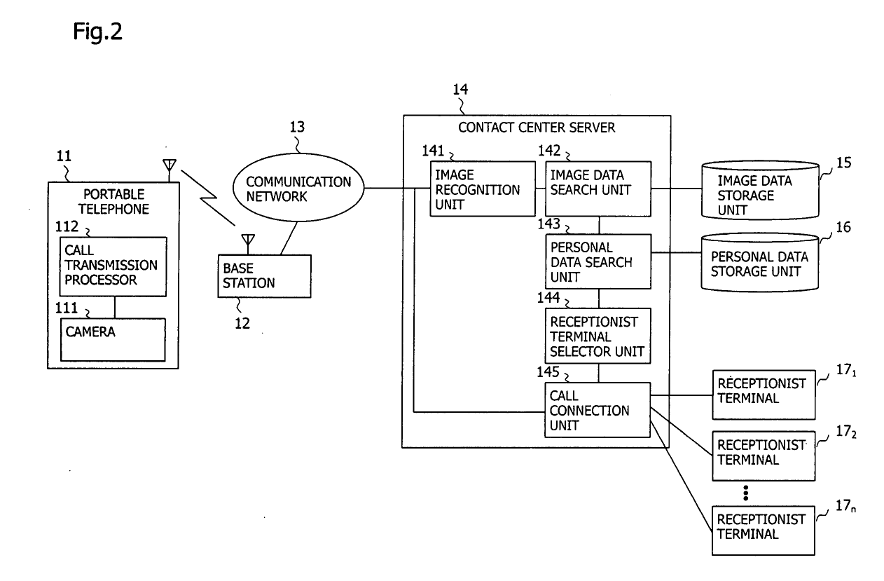

FIG. 2 illustrates the configuration of a contact center system according to a first embodiment of the present invention.

As shown in FIG. 2, the contact center system of this embodiment comprises portable telephone 11; base station 12; communication network 13; contact center server 14; image data storage unit 15; personal data storage unit 16; and receptionist terminals 17₁-17ₙ, n being a natural number. While only one portable telephone 11 is illustrated in FIG. 2, the present invention is not limited to a system which includes only one portable telephone, but there are no particular limitations in configuration as long as one or more portable telephones 11 are included in a system.

Portable telephone 11 represents a caller terminal for use by a customer for placing a telephone call to contact center server 14 for claims related to articles and/or services and the like.

Receptionist terminals 17₁-17ₙ each receive a telephone call placed by a customer to contact center server 14, and are each used by a receptionist such as an operator who services the call.

Portable telephone 11 comprises camera 111 and call transmission processor 112.

Camera 111 is an image input means for taking an image of the face of a caller to capture the image.

Call transmission processor 112 performs transmission of a call to contact center server 14 and simultaneously transmission of the image of the face of the caller taken by camera 111 when a call is placed to contact center server 14.

Contact center server 14 comprises image recognition unit 141; image data search unit 142; personal data search unit 143; receptionist terminal selector unit 144; and call connection unit 145.

Image recognition unit 141 recognizes an image of the face of a caller transmitted from portable telephone 11 simultaneously with a call from portable telephone 11 which has been accepted by contact center server 14. Image data search unit 142 searches image data storage unit 15 for face image data which matches the image of the face of the caller recognized by image recognition unit 141 from among customer face image data stored in image data storage unit 15. Personal data search unit 143 searches personal data storage unit 16 for personal data corresponding to the customer face image data retrieved by image data search unit 142 from among personal data stored in personal data storage unit 143. Receptionist terminal selector unit 144 selects one or more receptionist terminals from among receptionist terminals 17₁-17ₙ based on the customer personal data retrieved by personal data search unit 143. Call connection unit 145 connects the call from portable telephone 11 to a receptionist terminal which is available for answering the call from among receptionist terminals selected by receptionist terminal selector unit 144.

Assume in this embodiment that customer face image data in image data storage unit 15 and customer personal data in personal data storage unit 16 have been previously collected from customers and stored therein. Assume also that customer face image data in image data storage unit 15 and customer personal data in personal data storage unit 16 are related to each other by identification numbers such as customer IDs for identifying customers. Customer personal data may include the name, address, telephone number, customer ID, grade (which is higher for better customers), article purchase history, service utilization history, contents of claims made in the past by the customer, receptionist ID for identifying a receptionist who has handled a telephone call from that customer in the past, and the like.

Also, this embodiment may employ any known technologies for image recognition in image recognition unit 141 and for the image search in image data search unit 142 as long as they can implement the foregoing operations, so that detailed description thereon is omitted.

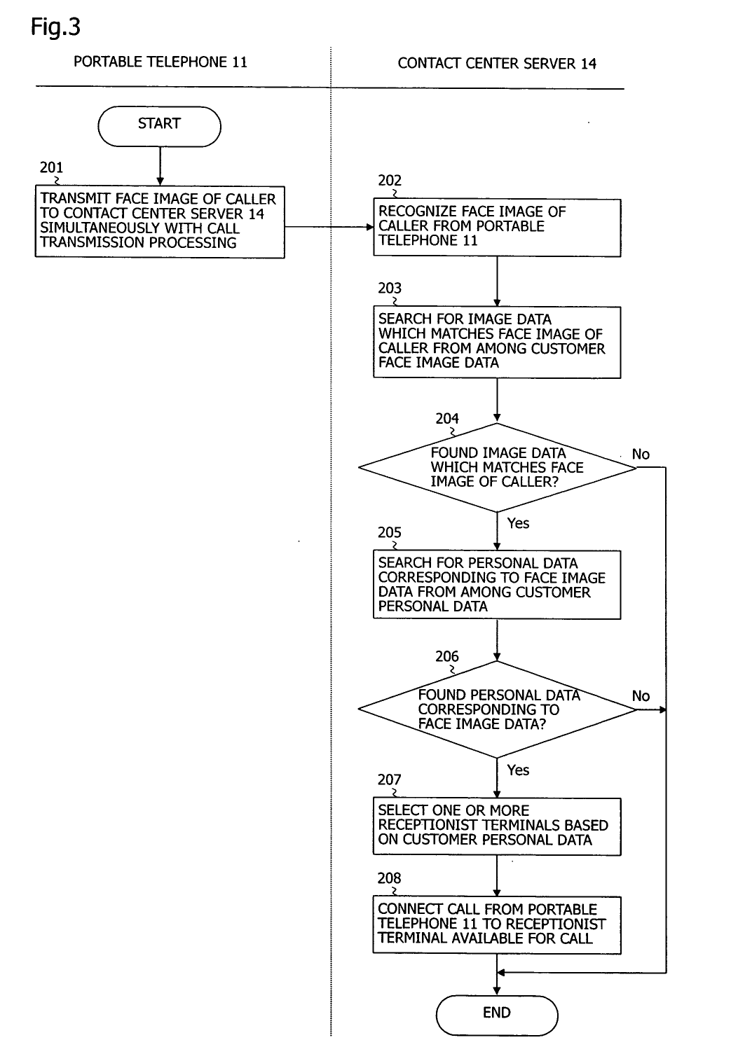

Next, the operation of the contact center system in this embodiment will be described with reference to a flow chart of FIG. 3.

First, a caller makes a setting on portable telephone 11 for transmitting an image of his/her own face taken by camera 111, and operates portable telephone 11 for placing a telephone call to contact center server 14.

In response, in portable telephone 11, call transmission processor 112 transmits a call to contact center server 14 through base station 12 and communication network 13, and simultaneously transmits the image of the face of the caller taken by camera 111 to contact center server 14 at step 201.

In contact center server 14, at step 202, image recognition unit 141 recognizes the image of the face of the caller transmitted from portable telephone 11. Then, at step 203, image data search unit 142 searches image data storage unit 15 for face image data which matches the image of the face of the caller recognized by image recognition unit 141 from among face image data stored in image data storage unit 15. As a result, if image data search unit 142 finds customer face image data which matches the image of the face of the caller from portable telephone 11 at step 204, personal data search unit 143 then searches personal data storage unit 16 for personal data corresponding to the customer face image data from among personal data stored in personal data storage unit 16 at step 205. In this event, personal data search unit 143 searches personal data storage unit 16 using a key which is a customer identification number that relates the customer face image data in image data storage unit 15 to customer personal data stored in personal data storage unit 16. As a result, when personal data search unit 143 finds personal data corresponding to the customer face image data at step 206, receptionist terminal selector unit 144 selects one or more of receptionist terminals from receptionist terminals 17₁-17ₙ based on the customer personal data at step 207. Subsequently, at step 208, call connection unit 145 connects the call from portable telephone 11 to a receptionist terminal available for answering the call from among the receptionist terminals selected by receptionist terminal selector unit 144.

As described above, in this embodiment, upon receipt of a call from portable telephone 11 in contact center server 14, a customer is identified by an image of the face of a caller transmitted from portable telephone 11 simultaneously with the call, and the call is connected to one of receptionist terminals 17₁-17ₙ which are selected based on the customer personal data. Thus, even when a plurality of customers use portable telephone 11, an routing operation can be carried out for connecting a call to a receptionist terminal of the receptionist who can most effectively service the telephone call from the customer on a customer-by-customer basis.

Also, in this embodiment, in contact center server 14, image data storage unit 15 is searched for face image data which matches an image of the face of a caller transmitted from portable telephone 11, and the call is connected to one of receptionist terminals 17₁-17ₙ only when the face image data can be retrieved from image data storage unit 15. Thus, the service can be provided only for particular customers whose face image data is stored in image data storage unit 15.

### Second Embodiment

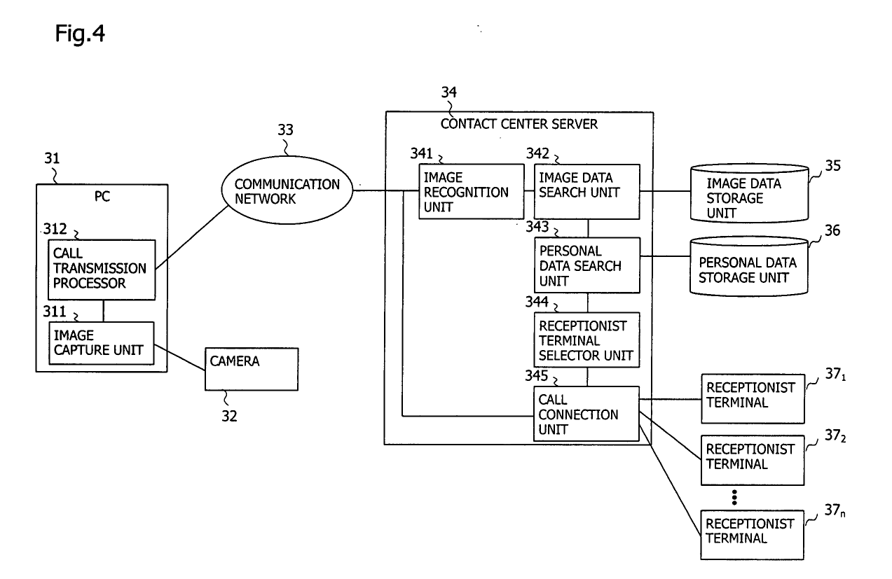

FIG. 4 illustrates the configuration of a contact center system according to a second embodiment of the present invention.

As shown in FIG. 4, the contact center system of this embodiment comprises PC (personal computer) 31; camera 32; communication network 33; contact center server 34; image data storage unit 35; personal data storage unit 36; and receptionist terminals 37₁-37ₙ, n being a natural number. While only one PC 31 is illustrated in FIG. 4, the present invention is not limited to a system which includes only one PC, but there are no particular limitations in configuration as long as one or more PC 31 are included in a system. Further alternatively, each PC 31 may use separate camera 32, or two or more PCs 31 may share single camera 32.

PC 31 represents a caller terminal for use by a customer for placing a call to contact center server 34 for claims related to articles or services and the like.

Receptionist terminals 37₁-37ₙ each receive a telephone call placed by a customer to contact center server 34, and are each used by a receptionist such as an operator who services the call.

PC 31 comprises an image capture unit 311 and a call transmission processor 312.

Image capture unit 311 represents an image input means for capturing an image of the face of a caller taken by camera 32 connected to PC 31.

Call transmission processor 312 performs transmission of a call to contact center server 14 and simultaneously transmission of the image of the face of the caller taken by camera 32 and captured into PC 31 by image capture unit 311 when a call is placed to contact center server 34.

Contact center server 34 comprises image recognition unit 341; image data search unit 342; personal data search unit 343; receptionist terminal selector unit 344; and call connection unit 345.

Image recognition unit 341 recognizes an image of the face of a caller transmitted from PC 31 simultaneously with a call from PC 31 which has been accepted by contact center server 34. Image data search unit 342 searches image data storage unit 35 for face image data which matches the image of the face of the caller recognized by image recognition unit 341 from among customer face image data stored in image data storage unit 35. Personal data search unit 343 searches personal data storage unit 36 for personal data corresponding to the customer face image data retrieved by image data search unit 342 from among personal data stored in personal data storage unit 343. Receptionist terminal selector unit 344 selects one or more receptionist terminals from among receptionist terminals 37₁-37ₙ based on the customer personal data retrieved by personal data search unit 343. Call connection unit 345 connects the call from PC 31 to a receptionist terminal which is available for answering the call from among receptionist terminals selected by receptionist terminal selector unit 344.

Assume in this embodiment that customer face image data in image data storage unit 35 and customer personal data in personal data storage unit 36 have been previously collected from customers and stored therein. Assume also that customer face image data in image data storage unit 35 and customer personal data in personal data storage unit 36 are related to each other by identification numbers such as customer IDs for identifying customers. Customer personal data may include the name, address, telephone number, customer ID, grade (which is higher for better customers), article purchase history, service utilization history, contents of claims made in the past by the customer, receptionist ID for identifying a receptionist who has handled a telephone call from that customer in the past, and the like.

Also, this embodiment may employ any known technologies for the image recognition in image recognition unit 341 and for the image search in image data search unit 342 as long as they can implement the foregoing operations, so that detailed description thereon is omitted.

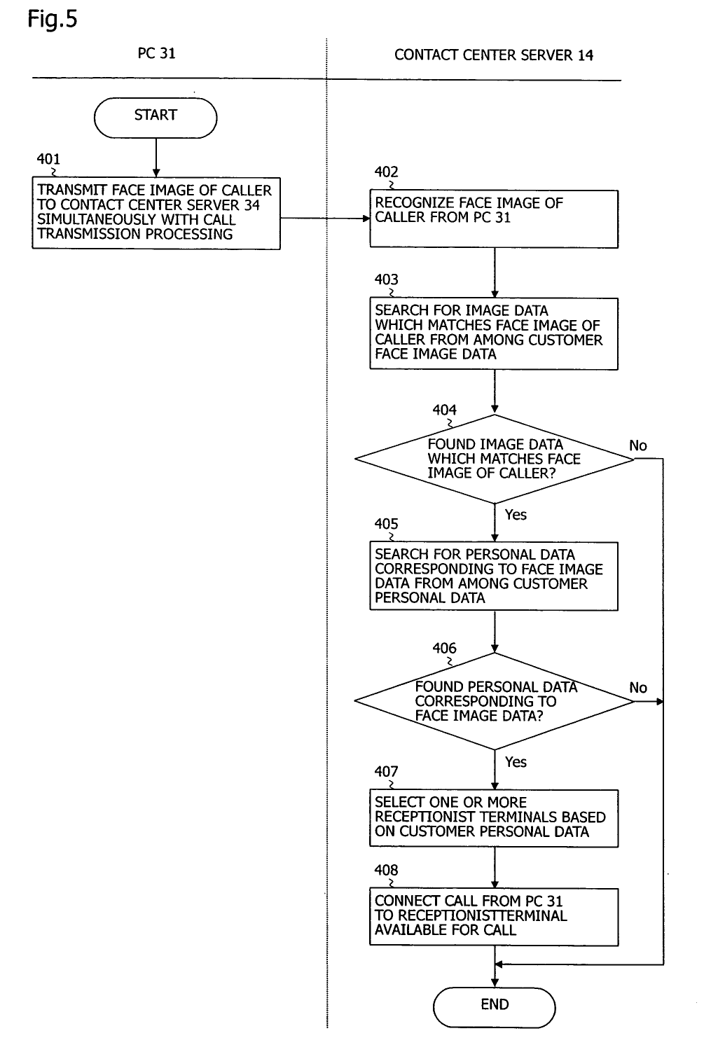

Next, the operation of the contact center system in this embodiment will be described with reference to a flow chart of FIG. 5.

First, a caller makes a setting on PC 31 for transmitting an image of his/her own face taken by camera 32, and operates portable telephone 11 for placing a telephone call to contact center server 34.

In response, in PC 31, call transmission processor 312 transmits a call to contact center server 34 through communication network 33, and simultaneously transmits the image of the face of the caller taken by camera 31 and captured into PC 31 by image capture unit 311 to contact center server 34 at step 401.

In contact center server 34, at step 402, image recognition unit 341 recognizes the image of the face of the caller transmitted from PC 31. Then, at step 403, image data search unit 342 searches image data storage unit 35 for face image data which matches the image of the face of the caller recognized by image recognition unit 341 from among face image data stored in image data storage unit 35. As a result, if image data search unit 342 finds customer face image data which matches the image of the face of the caller from PC 31 at step 404, personal data search unit 343 then searches personal data storage unit 36 for personal data corresponding to the customer face image data from among personal data stored in personal data storage unit 36 at step 405. In this event, personal data search unit 343 searches personal data storage unit 36 using a key which is a customer identification number that relates the customer face image data in image data storage unit 35 to customer personal data stored in personal data storage unit 36. As a result, when personal data search unit 343 finds personal data corresponding to the customer face image data at step 406, receptionist terminal selector unit 344 selects one or more of the receptionist terminals from receptionist terminals 37₁-37ₙ based on the customer personal data at step 407. Subsequently, at step 408, call connection unit 345 connects the call from PC 31 to a receptionist terminal available for answering the call from among the receptionist terminals selected by receptionist terminal selector unit 344.

As described above, in this embodiment, upon receipt of a call from PC 31 in contact center server 34, a customer is identified by an image of the face of a caller transmitted from PC 31 simultaneously with the call, and the call is connected to one of receptionist terminals 37₁-37ₙ which are selected based on the customer personal data. Thus, even when a plurality of customers use PC 31, a routing operation can be carried out for connecting a call to a receptionist terminal of the receptionist who can most effectively service the telephone call from the customer on a customer-by-customer basis.

Also, in this embodiment, in contact center server 34, image data storage unit 35 is searched for face image data which matches an image of the face of a caller transmitted from PC 31, and the call is connected to one of receptionist terminals 37₁-37ₙ only when the face image data can be retrieved from image data storage unit 35. Thus, the service can be provided only for particular customers whose face image data is stored in image data storage unit 35.

While the foregoing first and second embodiments have been described in connection with portable telephone 11 and PC 31, respectively, which are examples of the caller terminal, the present invention is not limited to such caller terminals. In other words, the caller terminal according to the present invention may be any terminal as long as it contains a camera function or can capture an image taken by a camera connected thereto and can transmit the image of the face of a caller taken by the camera simultaneously with call transmission processing.

Also, while the foregoing first and second embodiments have been described, by way of example, in connection with a contact center for handling telephone calls from customers for claims and the like, the present invention is not limited to such a contact center. For example, the present invention can be applied to an application for routing a call to a dedicated adviser on a member-by-member basis in a contact center which provides services exclusively for members. Also, the present invention can be applied to a contact center which provides a telephone banking service, requiring high security capabilities, for preventing fraudulent use.

Though not shown in the figures, the contact center server of the present invention comprises a recording medium which has recorded thereon a program for executing the routing method described above. This recording medium may be a magnetic disk, a semiconductor memory, or another recording medium. This program is read from the recording medium to the contact center server to control the operation of the contact center server. Specifically, a CPU in the contact center server instructs hardware resources in the contact center server to perform particular processing under the control of the program to implement the aforementioned functions.

While preferred embodiments of the present invention have been described using specific terms, such description is for illustrative purposes only, and it is to be understood that changes and variations may be made without departing from the spirit or scope of the following claims.

1. A contact center system comprising:
a caller terminal;
a plurality of receptionist terminals; and
a contact center server for performing a routing operation to connect a call from said caller terminal to one of said receptionist terminals, wherein:
said caller terminal includes:
image input means for capturing an image of a face of a caller; and
call transmission processing means for transmitting a call to said contact center server and simultaneously transmitting the image of the face of the caller applied to said image input means,
said contact center server includes:
image recognizing means responsive to a call received from said caller terminal for recognizing the image of the face of the caller transmitted from said caller terminal simultaneously with the call;
image data searching means for searching image data storing means for face image data which matches the image of the face of the caller recognized by said image recognizing means from among customer face image data stored in said image data storing means;
personal data searching means for searching personal data storing means for personal data corresponding to the customer face image data retrieved by said image data searching means from among personal data stored in said personal data storing means;
receptionist terminal selecting means for selecting one or more receptionist terminals from among said plurality of receptionist terminals based on the customer personal data retrieved by said personal data searching means; and
call connecting means for connecting the call from said caller terminal to a receptionist terminal which is available for answering the call from among the receptionist terminals selected by said receptionist terminal selecting means.

2. The contact center system according to claim 1, wherein said image input means comprises a camera.

3. The contact center system according to claim 1, wherein said image input means is image capturing means for capturing an image taken by a camera connected to said caller terminal.

4. A contact center server for performing a routing operation to connect a call from a caller terminal to one of receptionist terminals, said server comprising:
image recognizing means responsive to a call received from said caller terminal for recognizing the image of the face of the caller transmitted from said caller terminal simultaneously with the call;
image data searching means for searching image data storing means for face image data which matches the image of the face of the caller recognized by said image recognizing means from among customer face image data stored in said image data storing means;
personal data searching means for searching personal data storing means for personal data corresponding to the customer face image data retrieved by said image data searching means from among personal data stored in said personal data storing means;
receptionist terminal selecting means for selecting one or more receptionist terminals from among said plurality of receptionist terminals based on the customer personal data retrieved by said personal data searching means; and
call connecting means for connecting the call from said caller terminal to a receptionist terminal which is available for answering the call from among the receptionist terminals selected by said receptionist terminal selecting means.

5. A routing method for connecting a call from a caller terminal to one of receptionist terminals in a contact center server, said method comprising the steps of:
upon receipt of a call from said caller terminal, recognizing an image of a face of a caller transmitted from said caller terminal simultaneously with the call;
searching image data storing means for face image data which matches the recognized image of the face of the caller from among customer face image data stored in said image data storing means;
searching personal data storing means for personal data corresponding to the retrieved customer face image data from among personal data stored in said personal data storing means;
selecting one or more receptionist terminals from among said receptionist terminals based on the retrieved customer personal data; and
connecting the call from said caller terminal to a receptionist terminal available for answering the call from among the selected receptionist terminals.

6. A computer program for enabling a computer to execute a routing operation to connect a call from a caller terminal to one of the receptionist terminals, said computer program comprising:
a first set of instructions for, upon receipt of a call from said caller terminal, recognizing an image of a face of a caller transmitted from said caller terminal simultaneously with the call;
a second set of instructions for searching image data storing means for face image data which matches the recognized image of the face of the caller from among customer face image data stored in said image data storing means;
a third set of instructions for searching personal data storing means for personal data corresponding to the retrieved customer face image data from among personal data stored in said personal data storing means;
a fourth set of instructions for selecting one or more receptionist terminals from among said receptionist terminals based on the retrieved customer personal data; and
a fifth set of instructions for connecting the call from said caller terminal to a receptionist terminal available for answering the call from among the selected receptionist terminals.
